(19) United States
(12) Patent Application Publication
(10) Pub. No.: US 2021/0144813 A1
(43) Pub. Date: May 13, 2021

(54) HEAT GENERATOR

(71) Applicant: DENSO CORPORATION, Kariya-city (KR)

(72) Inventors: Izuna TSUBOI, Kariya-city (JP); Yasuhito NOGUCHI, Kariya-city (JP); Atsushi YAMADA, Kariya-city (JP); Yoshiaki SUZUKI, Kariya-city (JP)

(21) Appl. No.: 17/151,427

(22) Filed: Jan. 18, 2021

Related U.S. Application Data
(63) Continuation of application No. PCT/JP2019/027551, filed on Jul. 11, 2019.

(30) Foreign Application Priority Data
Jul. 30, 2018 (JP) 2018-142648

(51) Int. Cl. H05B 3/06; B32B 7/12; B60H 1/22

(52) U.S. Cl. CPC H05B 3/06; B32B 7/12; B60H 1/2215; B32B 2307/206; H05B 2203/02; B32B 2307/202; H05B 2203/023

(57) ABSTRACT

A heat generator includes an electrode terminal, a heating element, an electrically conductive housing, and an insulator. The electrode terminal is stacked on the heating element in a stacking direction. The housing houses a stacked body formed of the heating element and the electrode terminal. The stacked body includes a pair of side wall surfaces each extending in the stacking direction, an element side end surface, and a terminal side end surface. The element side end surface is in close contact with the case inner wall surface. Both the terminal side end surface and the pair of side wall surfaces are entirely in close contact with the case inner wall through the insulator. The housing includes a pair of facing walls facing and extending along the pair of side wall surfaces to serve as a positioning member that restricts the heating element from moving in the intersecting direction.

### CROSS REFERENCE TO RELATED APPLICATIONS

The present application is a continuation application of International Patent Application No. PCT/JP2019/027551 filed on Jul. 11, 2019, which designated the U.S. and claims the benefit of priority from Japanese Patent Application No. 2018-142648 filed on Jul. 30, 2018. The entire disclosure of all of the above applications are incorporated herein by reference.

### TECHNICAL FIELD

The present disclosure relates to a heat generator for an electric heater.

### BACKGROUND ART

A heat generator used for an electric heater includes a heating element, an electrode terminal, and an electrically conductive case. The electrode terminal is stacked on the heating element such that one surface of the electrode terminal is in contact with the heating element. The case is in contact with the heat generator in a state the case is insulated from the electrode terminal by an insulator. The heat generator includes a pair of protrusions protruding from the electrode terminal to the heating element. The heating element is mounted between the pair of protrusions.

### SUMMARY

A heat generator for an electric heater includes an electrode terminal, a heating element, an electrically conductive housing, and an insulator. The electrode terminal has a flat plate shape. The heating element has a flat plate shape and is configured to generate heat when energized. The electrode terminal is stacked on the heating element in a stacking direction to be electrically in contact with each other. The housing houses a stacked body formed of the heating element and the electrode terminal. The insulator has a film shape or a sheet shape. The insulator has both insulation property and thermal conductivity that is greater than that of air.

The housing includes a case inner wall defining a housing space for the stacked body. The stacked body has a pair of side wall surfaces and a pair of stacking end surfaces. Each of the pair of side wall surfaces extends in the stacking direction of the heat element and the electrode terminal. Each of the pair of stacking end surfaces extends in an intersecting direction intersecting with the stacking direction and connected to the pair of side wall surfaces. The pair of stacking end surfaces are formed of an element side end surface defined by the heating element and a terminal side end surface defined by the electrode terminal. The stacked body is housed in the housing such that the element side end surface is in close contact with the case inner wall and both the terminal side end surface and the pair of side wall surfaces are entirely in close contact with the case inner wall through the insulator interposed between the stacked body and the case inner wall. The housing includes a pair of facing walls facing the pair of side wall surfaces. The pair of facing walls extend along the pair of side wall surfaces to serve as a positioning member that restricts the heating element from moving in the intersecting direction.

### BRIEF DESCRIPTION OF THE DRAWINGS

FIG. 1 is a schematic perspective view of an electric heater using a heating generator of a first embodiment.

FIG. 2 is a schematic perspective view of the heat generator of the first embodiment.

FIG. 3 is a schematic cross-sectional view of the heat generator of the first embodiment.

FIG. 4 is a schematic cross-sectional view of the heat generator of the first embodiment.

FIG. 5 is an explanatory diagram of steps for manufacturing the heat generator of the first embodiment.

FIG. 6 is an explanatory view of a part of an assembly step in the steps for manufacturing the heat generator of the first embodiment.

FIG. 7 is an explanatory view of a part of the assembly step in the steps for manufacturing the heat generator of the first embodiment.

FIG. 8 is an explanatory view of a part of the assembly step in the steps for manufacturing the heat generator of the first embodiment.

FIG. 9 is an explanatory view of a part of a joining step in the steps for manufacturing the heat generator of the first embodiment.

FIG. 10 is an explanatory diagram of steps for manufacturing a heat generator of a second embodiment.

FIG. 11 is an explanatory view of a joining step in the steps for manufacturing the heat generator of the second embodiment.

FIG. 12 is a schematic cross-sectional view of a heat generator of the third embodiment.

FIG. 13 is an explanatory diagram of steps for manufacturing a heat generator of a third embodiment.

FIG. 14 is an explanatory view of a part of an assembly step of the steps for manufacturing the heat generator of the third embodiment.

FIG. 15 is an explanatory view of a part of the assembly step of the steps for manufacturing the heat generator of the third embodiment.

FIG. 16 is an explanatory view of a part of the assembly step of the steps for manufacturing the heat generator of the third embodiment.

FIG. 17 is an explanatory view of a joining step of the steps for manufacturing the heat generator of the third embodiment.

### DESCRIPTION OF EMBODIMENTS

To begin with, examples of relevant techniques will be described.

A heat generator used for an electric heater includes a heating element, an electrode terminal, and an electrically conductive case. The electrode terminal is stacked on the heating element such that one surface of the electrode terminal is in contact with the heating element. The case is in contact with the heat generator in a state the case is insulated from the electrode terminal by an insulator.

In order to simplify an assembly, the heat generator includes a pair of protrusions protruding from the electrode terminal to the heating element. The heating element is mounted between the pair of protrusions.

When the electrode terminal has the pair of protrusions, the electrode terminal can serve as a positioning member to define a position of the heating element. However, a stacked body of the heating element and the electrode terminal has an uneven complicated shape. If the stacked body has a complicated shape, a gap is likely to be defined between the stacked body and the case, which hinders the thermal conductivity of the heating element.

If the electrode terminal has the pair of protrusions, an area of the electrode terminal facing the case through the insulator is increased. Thus, it may be difficult to secure an insulating property between the electrode terminal and the case. These are the findings found by the diligent studies of the inventors of the present disclosure.

It is objective of the present disclosure to provide a heat generator that can secure an insulating property and improves a thermal conductivity.

According to an aspect of the present disclosure, a heat generator for an electric heater includes an electrode terminal, a heating element, an electrically conductive housing, and an insulator. The electrode terminal has a flat plate shape. The heating element has a flat plate shape and is configured to generate heat when energized. The electrode terminal is stacked on the heating element in a stacking direction to be electrically in contact with each other. The housing houses a stacked body formed of the heating element and the electrode terminal. The insulator has a film shape or a sheet shape. The insulator has both insulation property and thermal conductivity that is greater than that of air.

The housing includes a case inner wall defining a housing space for the stacked body. The stacked body has a pair of side wall surfaces and a pair of stacking end surfaces. Each of the pair of side wall surfaces extends in the stacking direction of the heat element and the electrode terminal. Each of the pair of stacking end surfaces extends in an intersecting direction intersecting with the stacking direction and connected to the pair of side wall surfaces. The pair of stacking end surfaces are formed of an element side end surface defined by the heating element and a terminal side end surface defined by the electrode terminal. The stacked body is housed in the housing such that the element side end surface is in close contact with the case inner wall and both the terminal side end surface and the pair of side wall surfaces are entirely in close contact with the case inner wall through the insulator interposed between the stacked body and the case inner wall. The housing includes a pair of facing walls facing the pair of side wall surfaces. The pair of facing walls extend along the pair of side wall surfaces to serve as a positioning member that restricts the heating element from moving in the intersecting direction.

As described above, by stacking the electrode terminal having a flat plate shape without protrusion and the heating element having a flat shape, a stacked body of the electrode terminal and the heating element has a simple outer shape. Thus, it becomes easy to make the element side end surface of the stacked body in close contact with the case inner wall and to make both the terminal side end surface of the stacked body and the pair of side surfaces in closed contact with the case inner wall through the insulator. Thus, gaps, which hinders the thermal conductivity, are less likely to generate between the housing and the stacked body.

In addition, the pair of facing walls of the housing facing the pair of side wall surfaces serve as a positioning member of the heating element. Compared to a configuration to dispose a positioning member at the electrode terminal, an area of the electrode terminal facing the housing through the insulator is decreased. Thus, the insulating property between the electrode terminal and the housing can be easily secured.

Thus, according to the heat generator of the present disclosure, an insulating property can be secured and a thermal conductive property can be improved.

Hereinafter, embodiments of the present disclosure will be described with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. The following embodiments may be partially combined with each other even if such a combination is not explicitly described as long as there is no disadvantage with respect to such a combination.

### First Embodiment

The present embodiment will be described with reference to FIGS. 1 to 9. In this embodiment, an example that a heat generator 20 of the present disclosure is applied for an electric heater 1 will be described. The electric heater 1 serves as an auxiliary heat source for air-heating by an air conditioner for a vehicle that conditions air in the vehicle cabin.

General air conditioner for a vehicle includes a heater core that uses, as a heat source, a cooling water for an internal combustion engine. The air conditioner is configured to heat air to be blown toward the vehicle cabin by the heater core during the air-heating in the vehicle cabin. In such air conditioner for a vehicle, it may take time during the winter and the like to increase the temperature of the cooling water to an appropriate temperature for air-heating from when the vehicle is started.

To take measures for the above-described subject, the air conditioner for a vehicle includes an electric heater 1, as an auxiliary heat source for air-heating, configured to generate heat when energized. The electric heater 1 is disposed, for example, at a position downstream in an airflow direction of the heater core in an air passage through which air flows into the vehicle cabin. Thereby, the air conditioner for a vehicle can heat air to be blown into the vehicle cabin not only with the heater core but also with the electric heater 1.

As shown in FIG. 1, the electric heater 1 includes a heat exchange core 10, reinforcing members 11 and 12, and supporting members 13 and 14. The heat exchange core 10 is configured to heat an air to be blown into the vehicle cabin. Each of the reinforcing members 11 and 12 has a stick shape. The reinforcing members 11 and 12 reinforce both ends of the heat exchange core 10 in an up-down direction. The supporting members 13 and 14 are configured to support both ends of the heat exchange core 10 in a width direction.

The heat exchange core 10 is configured such that multiple heat generators 20 to heat the air and multiple heat transfer fins 30 to promote heat dissipation are alternately stacked with each other. In the heat exchange core 10, the heat generators 20 are arranged with predetermined gaps therebetween so that the air can flow through the gaps. The heat transfer fins 30 are located in the gaps. Thereby, the heat exchange core 10 can heat the air flowing through the gaps between the heat generators 20 by the heat generators 20.

As shown in FIG. 2, each of the heat generators 20 has a plate shape as an outer shape. Each of the heat generators 20 is arranged such that a longitudinal direction DR1 of the heat generator 20 extends along the width direction of the heat exchange core 10. The heat exchanger 20 has one end in the longitudinal direction DR1 having an external terminal T that is connected to an electrode terminal 24 which will be described later. A detail of the heat generator 20 will be described later.

Returning to FIG. 1, each of the heat transfer fins 30 is configured as a corrugated fin that is formed by bending a metal plate having good thermal conductivity such as aluminum into a wave shape. The heat transfer fin 30 is not limited to a corrugated fin and may be, for example, a plate fin.

Each of the reinforcing members 11 and 12 is formed of a stick shaped member extending in the longitudinal direction DR1 of the heat generator 20. The reinforcing members 11 and 12 are made of, for example, resin having high strength and high heat resistance.

Each of the supporting members 13 and 14 is formed of a block shaped member extending in the up-down direction of the heat exchange core 10. The supporting member 13 of the supporting members 13 and 14 has a connector C to connect the external elements T that are disposed at the one ends of the heat generators 20 in the longitudinal direction DR1 to a heater driving circuit, a power supply, and the like which are not shown.

Next, details of the heat generator 20 will be described with reference to FIGS. 2 to 4. As shown in FIG. 3, the heat generator 20 has a heating element 22, an electrode terminal 24, a housing 26, and an insulator 28. The heating element 22 has a flat plate shape and generates heat when energized. The electrode terminal 24 has a flat plate shape. The housing 26 houses a stacked body 25 of the heating element 22 and the electrode terminal 24. The insulator 28 has a film shape or a sheet shape and has an insulating property.

The heating element 22 is configured as a positive temperature coefficient thermistor whose electric resistance rises as the temperature increases. Specifically, the heating element 22 is a PTC thermistor whose electric resistance rises suddenly at a certain temperature.

As shown in FIG. 2, the heat generator 20 has multiple heating elements 22 each having a rectangular parallelepiped shape. The heating elements 22 are arranged in the longitudinal direction DR1 of the heat generator 20. Returning to FIG. 3, the electrode terminal 24 is stacked on the heating element 22 to be electrically connected to the heating element 22.

The electrode terminal 24 is a terminal serving as a positive electrode when electricity is supplied to the heating elements 22. The electrode terminal 24 is formed into a shape such that the stacked body 25 of the electrode terminal 24 and the heating element 22 has a simple shape. Specifically, the electrode terminal 24 has a flat plate shape having a dimension in the width direction similar to that of the heating element 22 such that the stacked body 25 of the electrode terminal 24 and the heating element 22 has a substantial rectangular parallelepiped shape.

The stacked body 25 of the heating element 22 and the electrode terminal 24 has side wall surfaces 251 and a pair of stacking end surface. The side wall surfaces 251 extend along a stacking direction DR2 in which the heating element 22 and the electrode terminal 24 are stacked with each other. The pair of stacking end surface each extend in an intersecting direction intersecting with the stacking direction DR2 and connected to the side wall surfaces 251. Specifically, the pair of the stacking end surfaces extend in the width direction perpendicular to the stacking direction DR2. The intersecting direction of this embodiment is the same as the width direction perpendicular to the stacking direction DR2.

The side wall surfaces 251 are formed of both the heating element 22 and the electrode terminal 24. The pair of stacking end surfaces are an element side end surface 252 defined by the heating element 22 and a terminal side end surface 253 defined by the electrode terminal 24. The element side end surface 252 is one surface of the heating element 22. The terminal side end surface 253 is one surface of the electrode terminal 24.

Here, that “the side wall surfaces 251 extend in the stacking direction DR2” is not only a state that the side wall surfaces 251 continuously extend in the stacking direction but also a state that the side wall surfaces 251 discontinuously extend in the stacking direction DR2. For example, when the dimension in the width direction DR3 of the heating element 22 is slightly different from that of the electrode terminal 24 due to manufacturing errors, the side wall surfaces 251 extend discontinuously in the stacking direction DR2. In this embodiment, the above-described state is included in that “the side wall surfaces 251 extend in the stacking direction”.

The housing 26 houses the stacked body 25 of the heating element 22 and the electrode terminal 24. The housing 26 is made of an electrically conductive material such as aluminum. The housing 26 has a case inner wall 260 that defines a housing space for the stacked body 25. The housing 26 is electrically connected to the heating element 22 with insulated from the electrode terminal 24 to serve as a negative electrode when electricity is supplied to the heating element 22.

Specifically, the housing 26 has a pair of cases 262 and 264 each of which includes one side opening and has a recessed shape cross-section. The pair of cases 262 and 264 are an inner case 262 and an outer case 264. The inner case 262 is fit into the outer case 264 such that the one opening of the inner case 262 located inside of the outer case 264 is closed by a bottom surface of the outer case 264 located outside of the inner case 262. That is, the inner case 262 is fit into the outer case 264 such that the one side opening of the inner case 262 is in contact with the bottom surface of the outer case 264. In this embodiment, the inner case 262 is a first case and the outer case 264 is a second case.

The inner case 262 has a dimension in the width direction DR3 slightly larger than that of the stacked body 25 to house the stacked body 25 and the insulator 28 therein. Specifically, the inner case 262 has an inner bottom wall 262a extending in the width direction DR3 and a pair of inner side walls 262b and 262c extending in the stacking direction of the stacked body 25. The pair of inner side walls 262b and 262c serve as a positioning member to restrict the heating element 22 from moving in the width direction DR3.

The outer case 264 has a dimension in the width direction slightly larger than that of the inner case 262 to house the inner case 262 therein. The outer case 264 has an outer bottom wall 264a extending in the width direction DR3 and a pair of outer side walls 264b and 264c extending in the stacking direction of the stacked body 25. The outer bottom wall 264a faces the inner bottom wall 262a through the stacked body 25 in the stacking direction DR2. The pair of the outer side walls 264b and 264c face the pair of inner side walls 262b and 262c in the width direction DR3.

In this embodiment, the inner bottom wall 262a, the pair of inner side walls 262b and 262c, and the outer bottom wall 264a define the housing space for the stacked body 25. Thus, the inner bottom wall 262a, the pair of inner side walls 262b and 262c, and the outer bottom wall 264a define the case inner wall 260. In this embodiment, the inner side walls 262b and 262c of the case inner wall 260 extend along the side wall surfaces 251 and serve as the positioning member that restricts the heating element 22 from moving in the width direction DR3. Thus, the pair of inner side walls 262b and 262c are a pair of facing walls that face the side wall surfaces 251.

The insulator 28 is configured to electrically insulate the electrode terminal 24 serving as a positive electrode from the housing 26 serving as a negative electrode. The insulator 28 is disposed to cover a surface of the inner case 262 facing the stacked body 25 and a surface of the inner case 262 facing the outer case 264.

The insulator 28 is made of a material that has an insulating property and thermal conductivity that is greater than that of air. The insulator 28 is configured to have flexibility and adhesiveness for serving as a joining member to join between the stacked body 25, the inner case 262, and the outer case 264.

Specifically, the insulator 28 includes a base portion 281 and adhesive portions 282 disposed on both sides of the base portion 281. The base portion 281 has an insulation property, high terminal conductivity, and flexibility. Each of the adhesive portions 282 is thermo-sensitive and expresses an adhesiveness when heated. The base portion 281 may be a silicon rubber that is great both insulating property and thermal conductivity and has a flexibility. The adhesive portions 282 may be made of thermosetting resin such as an epoxy resin.

In the heat generator 20 configured as described above, the stacked body 25 is housed in the housing 26 such that the element side end surface 252 is in close contact with the case inner wall 260 and both the terminal side end surface 253 and the side wall surfaces 251 are entirely in close contact with the case inner wall 260 through the insulator 28 interposed between the case inner wall 260 and the stacked body 25. That is, in the heat generator 20, the stacked body 25 is housed in the housing 26 such that no gaps is defined between the stacked body 25 and the housing 26.

Specifically, the element side end surface 252 is in close contact with an inner surface of the outer bottom wall 264a. The terminal side end surface 253 is in close contact with an inner surface of the inner bottom wall 262a through the insulator 28. The side wall surfaces 251 are in close contact with inner surfaces of the pair of inner side walls 262b and 262c through the insulator 28.

The insulator 28 is located between the inner case 262 and the stacked body 25 to join therebetween and is located between the inner case 262 and the outer case 264 to join therebetween. Specifically, the insulator 28 is disposed to cover the inner bottom wall 262a of the inner case 262 and the inner surface and an outer surface of the pair of inner side walls 262b and 262c.

Next, an outline of steps for manufacturing the heat generator 20 of this embodiment will be described with reference to FIGS. 5 to 9. As shown in FIG. 5, the heat generator 20 is formed through preparing step, assembly step, and joining step.

The preparing step includes preparing components of the heat generator 20. Specifically, the heating element 22, the electrode terminal 24, the inner case 262, the outer case 264, and the insulator 28 that are components of the heat generator 20 are prepared during the preparing step.

During the subsequent assembly step, the stacked body 25 is housed in the housing 26 such that the element side end surface 252 is in contact with the case inner wall 260 and both the terminal side end surface 253 and the side wall surfaces 251 are entirely in contact with the case inner wall 260 through the insulator 28.

As shown in FIG. 6, during the assembly step, the insulator 28 is disposed on the inner case 262. Specifically, the insulator 28 is disposed inside of the inner case 262 such that the insulator 28 covers the inner bottom wall 262a and the inner surface and the outer surface of the pair of inner side walls 262b and 262b.

Next, as shown in FIG. 7, during the assembly step, the stacked body 25 of the heating element 22 and the electrode terminal 24 is disposed inside of the inner case 262 on which the insulator 28 is disposed. Specifically, the stacked body 25 is housed in the inner case 262 such that the electrode terminal 24 is located to face the inner bottom wall 262a and the heating element 22 is located to face the opening end of the inner case 262. At this time, the pair of inner side walls 262b and 262c of the inner case 262 define a position of the stacked body 25 in the width direction DR3.

Next, as shown in FIG. 8, during the assembly step, the inner case 262 housing the stacked body 25 is assembled into the outer case 264. Specifically, the inner case 262 is fit into the outer case 264 such that the heating element 22 is in contact with the outer case 264.

As shown in FIG. 9, during the subsequent joining step, the assembly obtained through the assembly step is heated while the assembly is pressurized in both the stacking direction DR2 and the width direction DR3. In the assembly, the element side end surface 252 is in close contact with the case inner wall 260 and both the terminal side end surface 253 and the side wall surfaces 251 are entirely in close contact with the case inner wall 260 through the insulator 28 by pressure. Further, the insulator 28 expresses an adhesiveness by being heated, so that both the terminal side end surface 253 and the side wall surfaces 251 are entirely joined to the case inner wall 260 through the insulator 28 in a state where the element side end surface 252 is in close contact with the case inner wall 260. At this time, the outer case 264 and the inner case 262 are joined to each other by the insulator 28.

After these steps, the heat generator 20 that the element side end surface 252 is in close contact with the case inner wall 260 and both the terminal side end surface 253 and the side wall surfaces 251 are entirely in close contact with the case inner wall 260 through the insulator 28 can be obtained.

Next, an operation of the electric heater 1 of this embodiment will be described. When a heat source to heat an air in the vehicle cabin is insufficient during an air-heating mode to heat the air in the vehicle cabin, a controller of the air conditioner (not shown) transmits energization instruction signals, which instructs to energize the electric heater 1, to the heater driving circuit. The heater driving circuit starts to energize the electric heater 1 upon receiving the energization instruction signals.

In the electric heater 1, the heat generators 20 generate heat when energized. When air passes through between the heat generators 20 in this state, the air is heated to a desired temperature by the heat generators 20. The air heated by the heat generators 20 is blown to the vehicle cabin and the air-heating in the vehicle cabin is thereby performed.

Since the electric heater 1 describe above includes multiple heat generators 20 that generate heat when energized, the heat generators 20 that generate heat when energized can increase the temperature of the air, which is a heating target, to a desired temperature.

In particular, in the heat generator 20, the stacked body 25 formed by stacking the electrode terminal 24 that has a flat plate shape on the heating element 22 that has a flat plate shape is housed in the housing 26. Thus, the stacked body 25 has a simpler outer shape compared to a case that the electrode terminal 24 has a recessed shape.

Therefore, the element side end surface 252 is easily in close contact with the case inner wall 260 and the terminal side end surface 253 is easily in close contact with the case inner wall 260 through the insulator 28. Thus, gaps, which hinder the thermal conductivity, are less likely to be defined between the housing 26 and the stacked body 25. The heat generator 20 of this embodiment can efficiently heat the air that is a heating target.

In addition, the pair of inner side walls 262b and 262c of the case inner wall 260 that face the side wall surfaces 251 serve as a positioning member that restricts the heating element 22 from moving in an intersecting direction intersecting with the stacking direction DR2. Thus, an area of the electrode terminal 24 that faces the housing 26 through the insulator 28 can be reduced compared to a configuration that the electrode has a positioning member. Therefore, an insulating property between the electrode terminal 24 and the housing 26 can be easily secured.

If the stacked body 25 is fixed into the case inner wall 260 by deforming the housing 26 such as by caulking, gaps that hinder the thermal conductivity may be formed between the housing 26 and the stacked body 25 along with the deformation of the housing 26.

In contrast, in the heat generator 20 of this embodiment, the insulator 28 has both flexibility and adhesiveness and the stacked body 25 is joined to the case inner wall 260 of the housing 26 by the insulator 28. Specifically, the insulator 28 has thermosensitive adhesive portions 282 that express adhesiveness when heated. The stacked body 25 is joined to the case inner wall 260 by the insulator 28 expressing the adhesiveness when heated.

Therefore, gaps that hinder the thermal conductivity are less likely to generate between the housing 26 and the stacked body 25, thereby improving the thermal conductivity of the heat generator 20. In addition, since the stacked body 25 is joined to the case inner wall 260 by heating the insulator 28, the steps for manufacturing the heat generator 20 can be simplified compared to a case that step for deforming the housing 26 such as caulking is necessary. This greatly contributes to the cost reduction of the heat generator 20.

Specifically, the heat generator 20 includes the housing 26 that has the inner case 262 and the outer case 264. Each of the inner case 262 and the outer case 264 has one end opening and a recessed shape cross-section. The inner case 262 is fit into the outer case 264 such that the one end opening of the inner case 262 is closed by the bottom surface of the outer case 264. The stacked body 25 is housed in the housing 26 such that the element side end surface 252 is in close contact with the bottom surface of the outer case 264 and both the terminal side end surface 253 and the side wall surfaces 251 are entirely in close contact with the inner surface of the inner case 262 through the insulator 28. The insulator 28 is disposed between the inner case 262 and the stacked body 25 to join therebetween and disposed between the inner case 262 and the outer case 264 to join therebetween.

Thus, the stacked body 25 is housed in the housing 26 in a state where the heating element 22 is in contact with the housing 26 and the electrode terminal 24 is insulated from the housing 26. In particular, since the stacked body 25 is joined to the housing 26 and the pair of cases 262 and 264 of the housing 26 are joined to each other by the insulator 28, the steps for manufacturing the heat generator 20 can be simplified.

If an insulating member having a plate shape or a brock shape, which has a relatively thick thickness, to secure an insulating property is used as the insulator 28 and the insulating member is disposed between the stacked body 25 and the housing 26, the heat generator 20 becomes large.

In contrast, in this embodiment, the insulator 28 has a film shape or a sheet shape. Thus, if the insulator 28 is disposed between the stacked body 25 and the housing 26, a size of the heat generator 20 is not greatly affected. Therefore, the heat generator 20 of this embodiment can reduce its size compared to a case that a plate-shaped or brock-shaped insulating member having a thickness larger than that of the insulator 28 is used as the insulator 28.

### Modification of First Embodiment

In the above-described first embodiment, the insulator 28 has a base portion 281 that has both good insulating property and thermal conductivity and the adhesive portions 282 that express adhesiveness. However, the insulator 28 is not limited to this configuration. The insulator 28 may be a liquid or gel-like insulating adhesive that has good insulating property, good thermal conductivity, flexibility, and adhesiveness.

In the above-described first embodiment, specific examples are described as the assembly step of assembling components of the heat generator 20. However, the assembly step is not limited this specific examples. An assembling order of the components of the heater generator 20 may be appropriately changed according to a production line, workability, and the like. The same also applies to the following embodiments.

### Second Embodiment

Next, a second embodiment will be described with reference to FIGS. 10 and 11. In this embodiment, a part of the steps for manufacturing heat generator 20 is different from that of the first embodiment. In this embodiment, different portions from the first embodiment are mainly described and descriptions of portions similar to the first embodiment will be omitted.

The adhesive portions 282 of the insulator 28 of this embodiment are configured to express an adhesiveness by a heat of the heating element 22 generated when energized. That is, the adhesive portions 282 are configured to express adhesiveness by a heat in a temperature range in which the heating element 22 has when energized.

Next, steps for manufacturing the heat generator 20 of this embodiment will be described with reference to FIGS. 10 and 11. The preparing step and the assembly step of the steps for manufacturing the heat generator 20 of this embodiment are similar to those of the first embodiment. Thus, descriptions thereof are omitted.

As shown in FIG. 10, the heating element 22 of the assembly obtained through the assembly step is energized during the joining step. Specifically, as shown in FIG. 11, the heating element 22 disposed inside of the housing 26 is heated by connecting the electrode terminal 24 and the housing 26 to an external power supply EP. Thereby, the insulator 28 expresses adhesiveness by a heat of the heating element 22 generated when energized and the stacked body 25 is joined to the case inner wall 260 of the housing 26 by the insulator 28.

The heat generator 20 of this embodiment is configured such that the stacked body 25 is joined to the case inner wall 260 by the insulator 28 expressing adhesiveness by a heat of the heating element 22. Thus, the steps for manufacturing the heat generator 20 can be simplified compared to a case that external heat is applied to the assembly to give the insulator 28 adhesiveness.

### Modification of Second Embodiment

In the above-described second embodiment, the heating element 22 of the assembly obtained through the assembly step is energized during the joining step, but the joining step is not limited to this. The joining step may be a step of energizing the heating element 22 in a state where the assembly obtained through the assembly step is pressurized.

### Third Embodiment

Next, a third embodiment will be described with reference to FIGS. 12 to 17. This embodiment is different from the first embodiment in that the outer case 264 is fixed to the inner case 26 by plastically deforming a part of the housing 26. In this embodiment, different portions from the first embodiment are mainly described and descriptions of portions similar to the first embodiment will be omitted.

As shown in FIG. 12, the inner case 262 has a pair of tilted portions 262d and 262e that are tilted relative to the stacking direction DR2 and the width direction DR3. The pair of tilted portions 262d and 262e are located at outer portions of the inner case 262 connecting between the pair of inner side walls 262b and 262c. The pair of tilted portions 262d and 262e are formed by, for example, chamfering processing.

The outer case 264 has opening end portions 264d and 264e that define the one end opening. The opening end portions 264d and 264e are disposed on tip ends of the pair of outer side walls 264b and 264c. The opening end portions 264d and 264e of the outer side walls 264b and 264c are overlapped with the pair of tilted portions 262d and 262e in the width direction DR3.

The outer case 264 is fixed to the inner case 262 by the opening end portions 264d and 264e plastically deformed toward the inner case 262. That is, in the heat generator 20 of this embodiment, the outer case 264 is fixed to the inner case 262 by plastically deforming a part of the housing 26.

An insulator 28A is made of a material that has both an insulating property and a thermal conductivity greater than that of air. The insulator 28A has a flexibility but does not have adhesiveness, which is different from the insulator 28 of the first embodiment.

The insulator 28A is disposed to cover the inner bottom wall 262a of the inner case 262 and the inner surface of the pair of inner side walls 262b and 262c to insulate the electrode terminal 24 from the housing 26.

Next, steps for manufacturing the heat generator 20 of this embodiment will be described with reference to FIGS. 13 to 17. The preparing step of the steps for manufacturing the heat generator 20 of this embodiment is similar to that of the first embodiment. Thus, descriptions thereof will be omitted.

As shown in FIGS. 13 to 16, during the assembly step, the stacked body 25 is housed in the housing 26 such that the element side end surface 252 is in contact with the case inner wall 260 and both the terminal side end surface 253 and the side wall surfaces 251 are entirely in contact with the case inner wall 260 through the insulator 28A.

As shown in FIG. 14, during the assembly step, the insulator 28A is disposed on the inner case 262 at first. Specifically, the insulator 28A is disposed inside of the inner case 262 to cover the inner bottom wall 262a and the inner surfaces of the pair of inner side walls 262b and 262c of the inner case 262.

Next, during the assembly step, as shown in FIG. 15, the stacked body 25 of the heating element 22 and the electrode terminal 24 is disposed inside of the inner case 262 on which the insulator 28A is disposed. At this time, the pair of inner side walls 262b and 262c of the inner case 262 define a position of the stacked body 25 in the width direction DR3.

Next, during the assembly step, as shown in FIG. 16, the inner case 262 on which the stacked body 25 is disposed is fit into the outer case 264. At this time, the inner case 262 is fit into the outer case 264 such that the heating element 22 is in contact with the outer bottom wall 264a of the outer case 264.

During the subsequent joining step, as shown in FIG. 17, the opening end portions 264d and 264e of the outer case 264 are plastically deformed to fix the outer case 264 to the inner case 262. Specifically, during the joining step, the opening end portions 264d and 264e of the outer case 264 are plastically deformed to be in contact with the pair of tilted portions 262d and 262e of the inner case 262.

The assembly obtained through the assembly portion is compressed in the stacking direction DR2 and the width direction DR3 when the opening end portions 264d and 264e are plastically deformed. Thereby, inside of the housing 26, the element side end surface 252 is in close contact with the case inner wall 260 and both the terminal side end surface 253 and the side wall surfaces 251 are entirely in close contact with the case inner wall 260 through the insulator 28A interposed between the stacked body 25 and the housing 26.

As described above, in the heat generator 20 of this embodiment, the outer case 264 is fixed to the inner case 262 by plastically deforming a part of the housing 26. In the housing 26, the element side end surface 252 is in close contact with the case inner wall 260 and both the terminal side end surface 253 and the side wall surfaces 251 are entirely in close contact with the case inner wall 260. According to the heat generator 20 of this embodiment, thermal conductivity can be improved while insulating property is secured similarly to that of the first embodiment.

### Modification of Third Embodiment

In the above-described third embodiment, the insulator 28A does not have adhesiveness, but the insulator 28A is not limited to this example. The insulator 28A may have adhesiveness.

### Other Embodiments

The representative embodiments of the present disclosure have been described above. However, the present disclosure is not limited to the above-described embodiments, and may be variously modified as follows.

In the above-described first and second embodiments, the insulator 28 has thermo-sensitive adhesive portions 282 that express adhesiveness when heated, but the insulator 28 is not limited to this example. The insulator 28 may include an adhesive that is cured even at room temperature such as a solvent volatile type adhesive. The insulator 28 is not limited to a solid that has a fixed shape. The insulator 28 may be, for example, a liquid or gel-like insulating adhesive.

In the above embodiment, the heating element 22 is configured with a PTC thermistor, but the heating element 22 is not limited to this example. The heating element 22 may be element other than a PTC thermistor while the heating element 22 generates heat when heated.

In the above-described embodiments, the element side end surface 252 and the terminal side end surface 253 of the stacked body 25 extend in the width direction DR3 perpendicular to the stacking direction DR2, but the stacked body 25 is not limited to this example. The element side end surface 252 and the terminal side end surface 253 of the stacked body 25 may extend in a direction slightly offset from the width direction DR3.

In the above-described embodiment, the housing 26 is formed of the inner case 262 and the outer case 264, but the housing 26 is not limited to this example. The housing 26 may have a tubular shape having a rectangular shaped cross-section.

In the above-described embodiment, the heat generator 20 of this disclosure is applied for the electric heater 1 of the air conditioner for a vehicle, but an application target of the heat generator 20 is not limited to this example. The heat generator 20 of this embodiment can be applied for an electric heater of various devices other than the air conditioner for a vehicle.

Needless to say, in the embodiments described above, the elements constituting the embodiment are not necessarily essential unless clearly expressed as particularly essential, or considered as obviously essential in principle, for example.

In the embodiments described above, values such as numbers of the constituent elements, numerical values, quantities, and ranges in the embodiment are not limited to the specific values described herein unless clearly expressed as particularly essential, or considered as obviously limited to the specific values in principle, for example.

In the embodiments described above, the shapes, positional relationships, or other conditions of the constituent elements and the like described in the embodiment are not limited to specific shapes, positional relationships, or other conditions unless clearly expressed, or limited to the specific shapes, positional relationships, or other conditions in principle.

### (Overview)

According to a first aspect shown in a part or all parts of the above embodiments, a heat generator includes an electrode terminal, a heating element, a housing, and an insulator. The electrode terminal has a flat plate shape. The heating element has a flat plate shape and is configured to generate heat when energized. The housing houses a stacked body of the heating element and the electrode terminal. The insulator has a film shape or sheet shape. The housing has a case inner wall that defines a housing space for the stacked body. The stacked body has a pair of side wall surfaces and a pair of stacking end surfaces. Each of the pair of side wall surfaces extends in the stacking direction of the heat element and the electrode terminal. Each of the pair of stacking end surfaces extends in an intersecting direction intersecting with the stacking direction and connected to the pair of side wall surfaces. The pair of stacking end surfaces are formed of an element side end surface defined by the heating element and a terminal side end surface defined by the electrode terminal. The stacked body is housed in the housing such that the element side end surface is in close contact with the case inner wall surface and both the terminal side end surface and the pair of side wall surfaces are entirely in close contact with the case inner wall through the insulator interposed between the stacked body and the case inner wall surface. The housing includes a pair of facing walls facing the pair of side wall surfaces. The pair of facing walls extend along the pair of side wall surfaces to serve as a positioning member that restricts the heating element from moving in the intersecting direction.

According to a second aspect, the insulator of the heat generator has a flexibility and an adhesiveness. The stacked body is joined to the case inner wall by the insulator.

When the stacked body is fixed to the case inner wall by deforming the housing, for example by caulking, gaps that hinder the thermal conductivity may be formed between the housing and the stacked body along with the deformation of the housing.

By joining the stacked body to the case inner wall with the insulator having a flexibility and an adhesiveness, the gaps that hinder the thermal conductivity are less likely to be defined between the housing and the stacked body. Therefore, the thermal conductivity of the heat generator can be improved.

According to a third aspect, the insulator of the heat generator has thermosensitive adhesive portions that express adhesiveness when heated. The stacked body is joined to the case inner wall by the insulator expressing the adhesiveness by being heated.

Since the stacked body is joined to the case inner wall by heating the insulator, steps for manufacturing the heat generator can be simplified compared to a case that a step for deforming the housing such as caulking step is necessarily.

According to a fourth aspect, the adhesive portions of the heat generator express adhesiveness by a heat of the heating element generated when energized. The stacked body is joined to the case inner wall by the insulator expressing the adhesiveness by a heat of the heating element.

Since the stacked body can be fixed to the case inner wall by the insulator expressing the adhesiveness by a heat of the heating element, the steps for manufacturing the heat generator can be simplified compared to a case that an external heat is applied to give the insulator adhesiveness.

According to a fifth embodiment, the housing of the heat generator is formed of a pair of cases each having one side opening and a recessed cross-section. The pair of cases are a first case and a second case. The first case is fit into the second case such that the one side opening of the first case is closed by a bottom surface of the second case. The stacked body is housed in the housing such that the element side end surface is in close contact with the bottom surface of the second case and both the terminal side end surface and the side wall surfaces are entirely in close contact with the inner surface of the first case through the insulator interposed between the stacked body and the housing. The insulator is disposed between the first case and the stacked body to join therebetween and is disposed between the first case and the second case to join therebetween.

Thus, the stacked body is housed in the housing in a state where the heating element is in contact with the housing and the electrode terminal is insulated from the housing. In particular, since the insulator joins both between the stacked body and the housing and between the pair of cases of the housing, steps for manufacturing the heat generator can be simplified.

According to a sixth aspect, the housing of the heat generator has a pair of cases each having one end opening and has a recessed cross-section. The pair of cases are a first case and a second case. The first case is fit into the second case such that the one side opening of the first case is closed by a bottom surface of the second case. The insulator is disposed to cover the entire of the inner surface of the first case. The stacked body is housed in the housing such that the element side end surface is in close contact with the bottom surface of the second case and both the terminal side end surface and the side wall surfaces are entirely in close contact with the inner surface of the first case through the insulator interposed between the stacked body and the housing. The second case has opening end portions defining the one side opening. The second case is fixed to the first case by the opening end portions plastically deformed toward the first case.

This also allows the housing to house the stacked body in a state where the heating element is in contact with the housing and the electrode terminal is insulated from the housing.

What is claimed is:

1. A heat generator for an electric heater, the heat generator comprising:
an electrode terminal that has a flat plate shape;
a heating element that has a flat plate shape and is configured to generate heat when energized, the electrode terminal being stacked on the heating element in a stacking direction to be electrically in contact with each other;
an electrically conductive housing that houses a stacked body formed of the heating element and the electrode terminal; and
an insulator that has a film shape or a sheet shape, the insulator having both insulation property and thermal conductivity that is greater than that of air, wherein
the housing includes a case inner wall defining a housing space for the stacked body,
the stacked body includes:
a pair of side wall surfaces each extending in the stacking direction of the heating element and the electrode terminal; and
a pair of stacking end surfaces each extending in an intersecting direction intersecting with the stacking direction and connected to the pair of side wall surfaces, the pair of stacking end surfaces being formed of an element side end surface defined by the heating element and a terminal side end surface defined by the electrode terminal,
the element side end surface is in close contact with the case inner wall surface,
both the terminal side end surface and the pair of side wall surfaces are entirely in close contact with the case inner wall through the insulator interposed between the stacked body and the case inner wall surface,
the housing includes a pair of facing walls facing the pair of side wall surfaces, and
the pair of facing walls extend along the pair of side wall surfaces to serve as a positioning member that restricts the heating element from moving in the intersecting direction.

2. The heat generator according to claim 1, wherein
the insulator has a flexibility and an adhesiveness, and
the stacking body is joined to the case inner wall by the insulator.

3. The heat generator according to claim 2, wherein
the insulator includes a thermo-sensitive adhesive portion that expresses the adhesiveness when heated, and
the stacked body is joined to the case inner wall by the insulator expressing the adhesiveness by being heated.

4. The heat generator according to claim 3, wherein
the adhesive portion expresses the adhesiveness by heat generated by the heating element when energized, and
the stacked body is joined to the case inner wall by the insulator expressing the adhesiveness by heat of the heating element.

5. The heat generator according to claims 2, wherein
the housing includes a first case and a second case each of which includes one side opening and has a recessed shape cross-section,
the first case is fit into the second case such that the one side opening of the first case is closed by a bottom surface of the second case,
the stacked body is housed in the housing case such that the element side end surface is in close contact with the bottom surface of the second case and both the terminal side end surface and the pair of side wall surfaces are entirely in close contact with an inner surface of the first case through the insulator,
the insulator is disposed between the first case and the stacked body to join the first case to the stacked body and between the first case and the second case to join the first case to the second case.

6. The heat generator according to claim 1, wherein
the housing includes a first case and a second case each of which includes one side opening and has a recessed shape cross-section, the second case having an opening end portion defining the one side opening of the second case,
the first case is fit into the second case such that the one side opening of the first case is closed by a bottom surface of the second case,
the insulator is configured to entirely cover an inner surface of the first case,
the stacked body is housed in the housing such that the element side end surface is in close contact with the bottom surface of the second case and both the terminal side end surface and the pair of side wall surfaces are entirely in close contact with the inner surface of the first case through the insulator, and
the second case is fixed to the first case by the opening end portion of the second case that is plastically deformed toward the first case.
